SEQUENCE LISTING (12 sequences)

SEQ ID NO: 1 - protein, 8 aa, synthetic construct
FFFFFFEE

SEQ ID NO: 2 - protein, 8 aa, synthetic construct
FFFFFFET

SEQ ID NO: 3 - protein, 8 aa, synthetic construct
FFFFFFEV

SEQ ID NO: 4 - protein, 9 aa, synthetic construct
FFFFFFEET

SEQ ID NO: 5 - protein, 8 aa, synthetic construct
YYYYYYEE

SEQ ID NO: 6 - protein, 8 aa, synthetic construct
YYYYYYET

SEQ ID NO: 7 - protein, 8 aa, synthetic construct
YYYYYYEV

SEQ ID NO: 8 - protein, 9 aa, synthetic construct
YYYYYYEET

SEQ ID NO: 9 - protein, 8 aa, synthetic construct
WWWWWWEE

SEQ ID NO: 10 - protein, 8 aa, synthetic construct
WWWWWWET

SEQ ID NO: 11 - protein, 8 aa, synthetic construct
WWWWWWEV

SEQ ID NO: 12 - protein, 9 aa, synthetic construct
WWWWWWEET

(19) United States
(12) Patent Application Publication
(10) Pub. No.: US 2026/0117106 A1
(43) Pub. Date: Apr. 30, 2026

(54) ANTI-FREEZE COMPOSITION BASED ON 2D AMPHIPHILIC PEPTIDE NANOSTRUCTURES

(71) Applicant: GWANGJU INSTITUTE OF SCIENCE AND TECHNOLOGY, Gwangju (KR)

(72) Inventors: EUN JI LEE, Gwangju (KR); SEONG GYU CHOI, Gwangju (KR); LEE SEO KIM, Gwangju (KR)

(21) Appl. No.: 19/369,548

(22) Filed: Oct. 27, 2025

(30) Foreign Application Priority Data
Oct. 28, 2024 (KR) 10-2024-0148921

(51) Int. Cl. C09K 3/18

(52) U.S. Cl. CPC C09K 3/18

(57) ABSTRACT

An antifreeze composition includes a self-assembled nanostructure of a compound represented by Formula 1A. The compound of Formula 1A self-assembles in an aqueous phase to form a Janus nanostructure. The nanostructure binds to the surface of ice and exhibiting activity that inhibits the growth of ice. the nanostructure may be a nanosheet or a nanofibril.

### CROSS REFERENCE TO RELATED APPLICATION AND CLAIM OF PRIORITY

This application claims the benefit under 35 USC § 119 of Korean Patent Application No. 10-2024-0148921 filed on Oct. 28, 2024 in the Korean Intellectual Property Office, the entire contents of which is incorporated herein by reference.

### REFERENCE TO AN ELECTRONIC SEQUENCE LISTING

A sequence listing electronically submitted on Oct. 27, 2025 as an XML file named 20251027 LC1252519_TU_SEQ.XML, created on Oct. 21, 2025 and having a size of 11,439 bytes, is incorporated herein by reference in its entirety.

### BACKGROUND

### 1. Field of the Invention

The present invention relates to an antifreeze composition based on two-dimensional (2D) amphiphilic peptide nanostructures.

This invention was developed with the support of the Ministry of Science and ICT of Korea through the National Research Foundation of Korea (NRF) under the following research projects: (1) High-Resolution Spatiotemporal Imaging and Transcription Control of Peptide Chiral Supramolecular Polymerization for an Encryption Platform (Grant No. 2022R1A2 C2012889; Project ID 2710017378), conducted at Gwangju Institute of Science and Technology (GIST) from Mar. 1, 2024 to Feb. 28, 2025, (2) Development of a Human-Derived Nano Cryopreservative Based on a Crystal Nucleation/Growth Inhibition Material Platform (Grant No. RS-2024-00405574; Project ID 2710006099), conducted at GIST from Apr. 1, 2024, to Dec. 31, 2024, and (3) Development of Antifreeze Protein-Mimetic AI-Integrated Self-Assembling Cell Cryopreservation Nanoagents being conducted at GIST from Mar. 1, 2025 to Dec. 31, 2026.

### 2. Description of the Related Art

As the production and consumption of frozen foods continue to increase, and as freezing is required for the storage of vaccines and oocytes for infertility treatments, interest in cryopreservation technologies for the long-term storage of food and biomaterials is increasing in the fields of food and biotechnology. However, during the freezing process, ice crystal formation may cause damage to cell membranes or organelles, and during the thawing process, ice recrystallization may occur, which may also damage cell membranes and lead to cellular dehydration. Such cellular damage may significantly degrade the quality of food or biomaterials. Therefore, suppressing the formation and recrystallization of ice crystals is one of the most critical aspects of cryopreservation technology.

Cryoprotective agents may be used to protect food or biomaterials from ice crystal formation. Currently used cryoprotective agents (CPAs), such as dimethyl sulfoxide, sodium phosphate, glycerol, polyethylene glycol, and polyvinyl alcohol, are widely used due to their suitability for mass production. However, CPAs have limitations in food and biotechnology applications because they are difficult to remove after use and may cause cytotoxicity or genetic mutations. In addition, the structural and functional tunability of polymer-based cryoprotective agents is limited due to difficulties in molecular modification.

To overcome these limitations, antifreeze proteins (AFPs) have recently attracted attention as alternatives to synthetic cryoprotective agents. AFPs are proteins that enable organisms such as animals, plants, and fungi living in low-temperature environments to survive at subzero temperatures by interacting with ice crystals and suppressing their growth and recrystallization. Although AFPs are highly effective in preventing ice formation, naturally derived AFPs still present challenges such as complex extraction processes, low purity, and high production costs.

Accordingly, the inventors of the present invention have developed an antifreeze composition based on two-dimensional amphiphilic peptide nanostructures, which is easy to synthesize and control, cost-effective to produce, and exhibits excellent biocompatibility, thereby making it applicable to the cryopreservation of food and biomaterials.

### SUMMARY

An object of the present invention is to provide an antifreeze composition including two-dimensional amphiphilic peptide nanostructures.
1. An antifreeze composition comprising a self-assembled nanostructure of a compound represented by Formula 1A below:

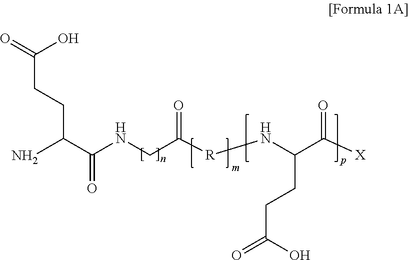

In Formula 1A,
R is phenylalanine, tyrosine or tryptophan,
X is valine, glutamic acid or threonine,
nis an integer from 5 to 20, m is an integer from 4 to 8, and p is 1 or 2.
2. The antifreeze composition according to the above 1, wherein the compound represented by Formula 1A is any one of the compounds represented by Formulas 2 to 5 below:

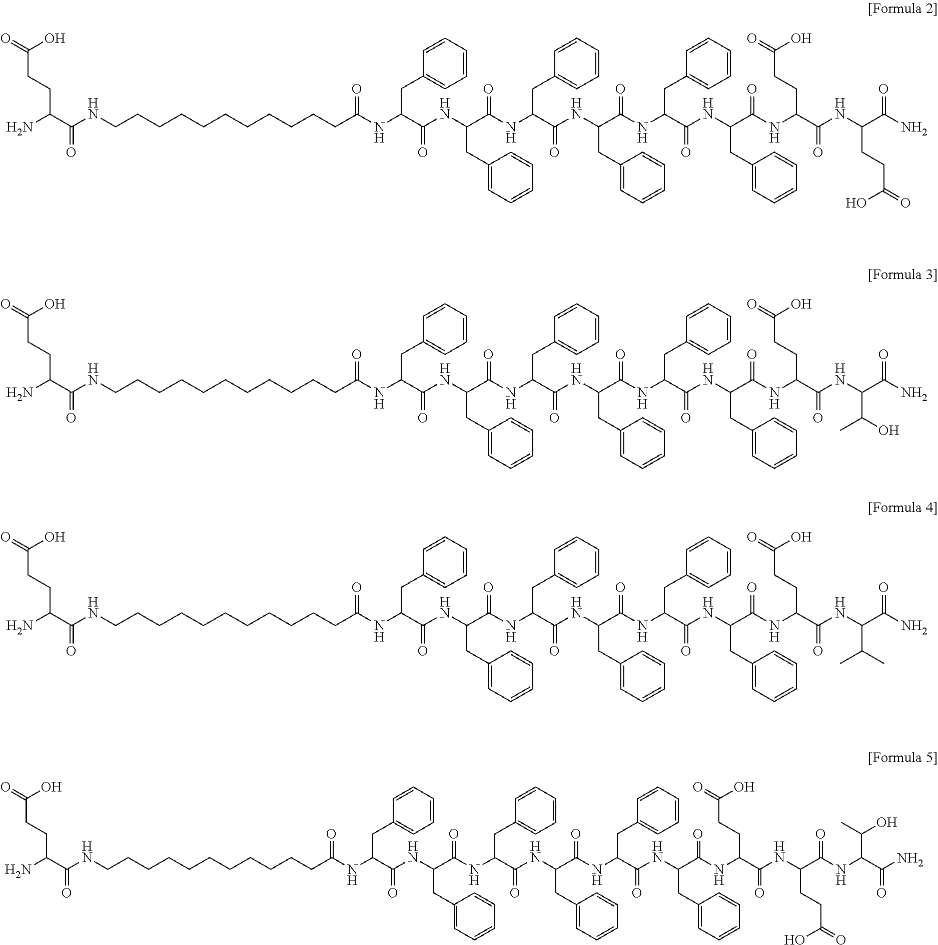

3. The antifreeze composition according to the above 1, wherein the nanostructure is a nanosheet or a nanofibril.
4. The antifreeze composition according to the above 3, wherein the nanosheet has a thickness of
2 to 10 nm.
5. The antifreeze composition according to the above 1, wherein the nanostructure has a Janus structure.
6. The antifreeze composition according to the above 1, wherein the self-assembly nanostructure results from hydrogen bonding between the compounds represented by Formula 1A.
7. The antifreeze composition according to the above 1, wherein the self-assembly nanostructure results from π-π interactions between the compounds represented by Formula 1A.
8. The antifreeze composition according to the above 1, wherein the X group binds to the surface of ice to inhibit the growth of ice.

The present invention may provide an antifreeze composition including two-dimensional amphiphilic peptide nanostructures.

The present invention may provide an antifreeze composition including a compound that self-assembles in an aqueous solution to form a Janus nanostructure.

The composition of the present invention may maximize the anti-freezing effect depending on the structure of a complex of an amphiphilic peptide and an ice-binding moiety.

The composition of the present invention exhibits biocompatibility and may be used for the cryopreservation of biomaterials, foods, or pharmaceutical products.

### BRIEF DESCRIPTION OF THE DRAWINGS

The above and other objects, features and other advantages of the present disclosure will be more clearly understood from the following detailed description taken in conjunction with the accompanying drawings, in which:

FIGS. 1A to 1D illustrate a molecular structure of amphiphilic peptides A) EAdoF6E-Glu, B) EAdoF6E-Thr, C) EAdoF6E-Val, and D) EAdoF6EE-Thr,

FIG. 2A illustrates synthetic routes of amphiphilic peptides using solid phase peptide synthesis, which are the synthetic routes of EAdoF6E-Glu, EAdoF6E-Thr, and EAdoF6E-Val, respectively;

FIG. 2B illustrates a synthetic route of amphiphilic peptide EAdoF6EE-Thr using solid phase peptide synthesis;

FIG. 3A illustrates HPLC spectra of amphiphilic peptides EAdoF6E-Glu, EAdoF6E-Thr, EAdoF6E-Val, and EAdoF6EE-Thr,

FIG. 3B illustrates MALDI-TOF/TOF mass spectra of amphiphilic peptides EAdoF6E-Glu, EAdoF6E-Thr, EAdoF6E-Val, and EAdoF6EE-Thr,

FIG. 4A schematically illustrates the amphiphilic peptide self-assembly into a 2D structure according to the classification between phenylalanine (yellow) and hydrocarbon tail (green) and incorporation of ice-binding moieties. FIG. 4B schematically illustrates the synthesized amphiphilic peptide molecules (EAdoF6E-Glu, EAdoF6E-Thr, EAdoF6E-Val, and EAdoF6EE-Thr);

FIG. 5A illustrates the critical micelle concentration (CMC) of EAdoF6E-Thr. The intersection of lines plotted linearly in two regions between 5-30 UM and 40-300 UM was estimated as the concentration at which the amphiphilic peptide could self-assemble. FIG. 5B illustrates UV-Vis and fluorescence spectra of EAdoF6E-Thr (0.25 mM, PBS) (excitation at 250 nm). FIGS. 5C to 5F illustrate CD spectra of EAdoF6E-Glu, EAdoF6E-Thr, EAdoF6E-Val, and EAdoF6EE-Thr,

FIGS. 6A to 6H visualize the aqueous self-assembled nanostructure of the peptides. FIGS. 6A to 6D are negatively and positively stained TEM images: A) EAdoF6E-Glu nanosheets, B) EAdoF6E-Thr nanofibrils, C) EAdoF6E-Val nanosheets, and D) EAdoF6EE-Thr nanosheets (0.25 mM, PBS). The inset image in FIG. 6A shows the fluorescence microscopy image of EAdoF6E-Glu nanosheets excited at 470 nm. FIG. 6E is a cryo-TEM image of EAdoF6E-Thr, and FIG. 6F is a cryo-TEM image of EAdoF6EE-Thr, which show that nanofibrils and nanosheets formed in aqueous solution, respectively. FIG. 6G is a small-angle X-ray scattering profile plot for solution structures of EAdoF6EE-Thr nanosheets fitted to lamellar sheets with a thickness of 5.5 nm. FIG. 6H is an AFM image of EAdoF6EE-Thr nanosheets, showing that the nanosheets were formed as a single layer.

FIG. 7A are cryomicroscope images showing the inhibition of ice crystal growth by amphiphilic peptides depending on the ice-binding moiety type (0.25 mM, PBS), where A is control PBS; B is EAdoF6E-Glu, EAdoF6E-Thr, and EAdoF6E-Val, respectively, and C is EAdoF6EE-Thr. Images were taken at 10-minute intervals.

FIG. 7B illustrates quantitative assessment of IRI activity of each peptide (0.25 mM, PBS) after ice crystals were annealed at −8° C. for 30 minutes, calculated from FIG. 7A. Error bars represent the standard deviation of three individual experiments. MGLS indicates the mean largest grain size relative to the PBS negative control; and

FIG. 7C is a set of images showing ice crystal growth of PBS and EAdoF6EE-Thr (0.25 mM, PBS) in a dynamic ice shaping study, with the images growing at a rate of 0.05° C./min from right to left.

### DETAILED DESCRIPTION OF THE INVENTION

The present invention provides an antifreeze composition including a self-assembled nanostructure of a compound represented by Formula 1A.

The present invention provides an antifreeze composition, in which the compound represented by Formula 1A self-assembles in an aqueous solution to form a Janus nanostructure and binds to the surface of ice to inhibit the growth of ice crystals.

The present invention provides an antifreeze composition including a compound represented by Formula 1A below, wherein the compound forms a self-assembled nanostructure.

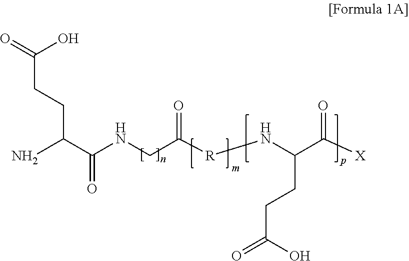

In Formula 1A above, R may be phenylalanine, tyrosine or tryptophan.

In Formula 1A above, X may be valine, glutamic acid or threonine.

In Formula 1A above, n may be from 5 to 20, 6 to 18, 7 to 16, 9 to 14, 10 to 12, or 11.

In Formula 1A above, m may be from 4 to 8, 5 to 8, 6 to 8, 6 to 7, or 6.

In Formula 1A above, p may be 1 or 2.

In one embodiment, in Formula 1A, R may be phenylalanine.

In one embodiment, in Formula 1A, n may be 11, m may be 6, and p may be 1 or 2.

The present invention provides an antifreeze composition including a compound represented by Formula 1B below, wherein the compound includes a self-assembled nanostructure.

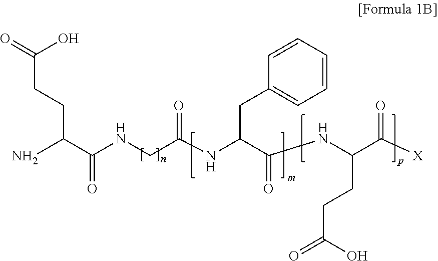

In Formula 1B above, X is valine, glutamic acid or threonine.

In Formula 1B above, n may be from 5 to 20, 6 to 18, 7 to 16, 9 to 14, 10 to 12, or 11.

In Formula 1B above, m may be from 4 to 8, 5 to 8, 6 to 8, 6 to 7, or 6.

In Formula 1B above, p may be 1 or 2.

In the composition of the present invention, the compound represented by Formula 1A may be any one of the compounds represented by Formulas 2 to 5 below.

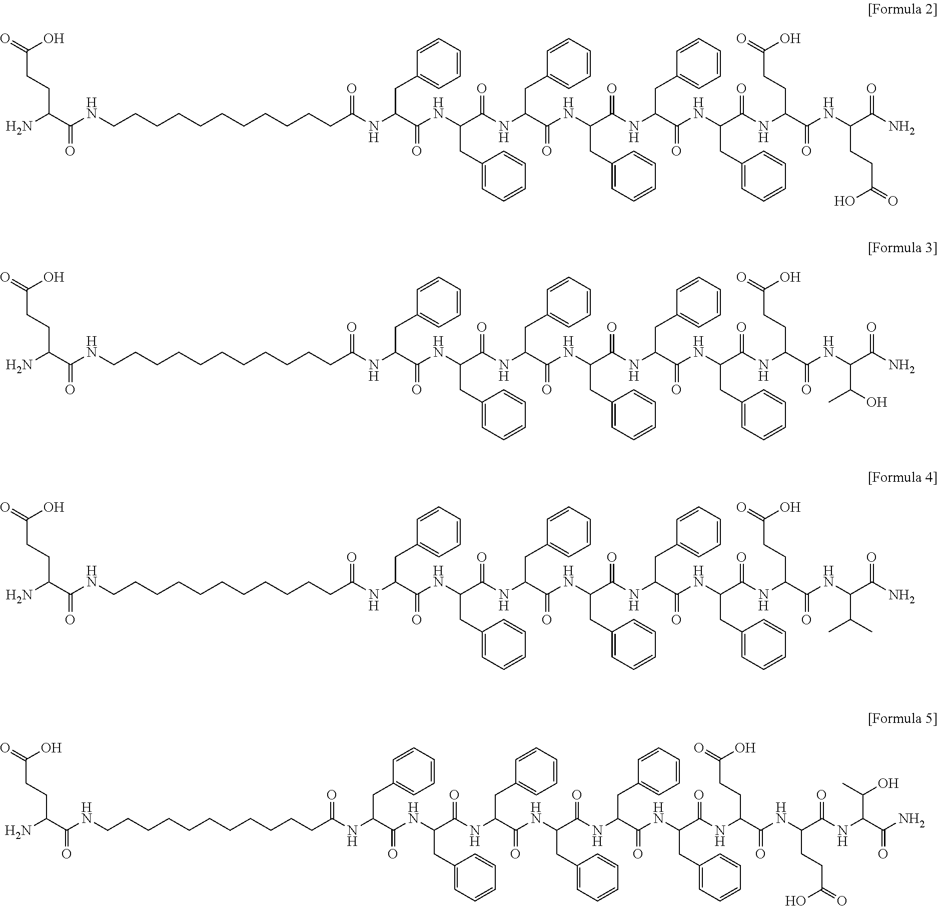

The compound of the present invention may effectively bind to ice by forming a two-dimensional nanostructure.

The self-assembled nanostructure formed by the compound of the present invention may have a large specific surface area and may mimic the structural and functional properties of natural antifreeze proteins, thereby exhibiting a more effective antifreeze effect.

The composition of the present invention, which includes amino acids as biomolecules, is biocompatible, making it suitable for the cryopreservation of biomaterials, foods, or pharmaceutical products.

The composition of the present invention may be used for the cryopreservation of cells or tissues.

The composition of the present invention may further include a conventional substance with antifreeze properties known in the art. For example, the composition may include dimethyl sulfoxide (DMSO), glycerol, 1,2-propanediol, sucrose, glucose, proline, galactose, lactose, glycine betaine, or fructose. In addition, when the composition is used for cell cryopreservation or food cryopreservation, it may include sucrose, glucose, lactose, glycine betaine, or fructose, which have low cytotoxicity.

Applicable cells for the composition of the present invention may include prokaryotic cells; eukaryotic cells; microorganisms; animal cells; cancer cells; sperm; oocytes; stem cells, including adult stem cells, embryonic stem cells, and induced pluripotent stem cells; blood cells, including cord blood, white blood cells, red blood cells, and platelets; and tissue cells, including kidney cells, liver cells, and muscle cells, but are not limited thereto.

Applicable tissues or organs for the composition of the present invention may include the cornea, kidney, heart, small intestine, pancreas, lung, liver, and the like, but are not limited thereto.

The composition of the present invention may further include a cryopreservation liquid for the cryopreservation of cells or tissues. The cryopreservation liquid may include water, saline, phosphate buffered saline (PBS), various cell culture media, and the like, but is not limited thereto.

The composition of the present invention may be used for cryopreservation in the food industry.

When foods are cryopreserved, ice recrystallization may occur during the thawing process prior to use. Upon ice recrystallization, ice crystals formed from moisture may grow, which can destroy cells or tissues present in the food, thereby resulting in deterioration in texture.

The composition of the present invention may inhibit the growth or recrystallization of ice, thereby preventing osmotic pressure changes or the death of cells or tissues within the food due to ice crystal growth, and thus minimizing deterioration in food quality.

Applicable foods for the composition of the present invention may include meats, fish and shellfish, fruits and vegetables, but are not limited thereto.

The composition of the present invention may also be used for cryopreservation in the pharmaceutical field.

When pharmaceutical products are cryopreserved, ice recrystallization may occur during the thawing process prior to use. Upon ice recrystallization, ice crystals formed from moisture may grow, and as the ice crystals grow, they may damage cell membranes, induce cell dehydration, and ultimately cause damage to cells and tissues present in the pharmaceutical products.

The composition of the present invention may inhibit the growth or recrystallization of ice, thereby preventing the death of cells or tissues within the pharmaceutical product caused by ice crystal growth, and thus preventing deterioration in the quality of the pharmaceutical product.

Applicable pharmaceutical products for the composition of the present invention may include, for example, pharmaceutical products manufactured using cells or tissues, but are not limited thereto.

Applicable pharmaceutical products for the composition of the present invention may include, for example, cell-based biopharmaceutical products such as cell therapy agents, stem cell therapy agents, immunotherapy agents, organoids, microspheres, or artificial tissues, but are not limited thereto.

In the composition of the present invention, the nanostructure may be a nanosheet or nanofibril.

The term “nanosheet” refers to a two-dimensional nanostructure having a thickness of about 1 to 100 nm, and the term “nanofibril” refers to a fiber having a diameter in the nanometer range.

In one embodiment, the compound (EAdoF6E-Glu) represented by Formula 2, the compound (EAdoF6E-Val) represented by Formula 4, and the compound (EAdoF6EE-Thr) represented by Formula 5 may form nanosheets. Among the compounds represented by Formulas 2 to 5 of the present invention, the compound (EAdoF6E-Thr) represented by Formula 3 may form nanofibrils.

In this specification, E represents glutamic acid (Glu), Ado represents aminododecanoic acid (ADDA), F represents phenylalanine, Thr represents threonine, and Val represents valine.

In the composition of the present invention, the nanosheet may have a thickness of 2 to 10 nm, 3 to 9 nm, 4 to 8 nm, 5 to 7 nm, 5 to 6 nm, or 5.5 to 6 nm.

In the composition of the present invention, the nanostructure may have a Janus structure.

The “Janus” structure refers to a structure in which materials present in different directions with respect to a central structure are composed of different materials rather than the same material.

The self-assembled nanostructure of the compound of the present invention is formed by the self-assembly of the inventive compound having hydrophilic and hydrophobic portions on opposite sides, and may have a Janus structure.

The self-assembled nanostructure formed by the compound of the present invention includes a hydrophilic region and a hydrophobic region. By introducing an ice-binding moiety into the hydrophilic region, the ice-binding moiety of the hydrophilic region may bind to ice, while the hydrophobic region may block the access of water molecules.

In the composition of the present invention, the self-assembly structure may result from hydrogen bonding between compounds represented by Formula 1A.

In the composition of the present invention, the self-assembly structure may result from hydrogen bonding between compounds represented by Formula 1B.

In the composition of the present invention, the self-assembly structure may result from hydrogen bonding between compounds represented by Formulas 2 to 5.

In the composition of the present invention, the self-assembly structure may result from T-IL interactions between compounds represented by Formula 1A.

In the composition of the present invention, the self-assembly structure may result from T-T interactions between compounds represented by Formula 1B.

In the composition of the present invention, the self-assembly structure may result from T-T interactions between compounds represented by Formulas 2 to 5.

In the compound of the present invention, R may be an aromatic amino acid, such as phenylalanine, tyrosine or tryptophan. In the compound of the present invention, R may facilitate hydrogen bonding between compounds by providing hydrogen bonds, and its aromatic ring may promote T-T interactions between compounds.

The composition of the present invention may inhibit ice growth by X binding to the surface of ice.

In the compound of the present invention, X may be valine, glutamic acid or threonine, and may serve as an ice-binding moiety that binds to the surface of ice. X may effectively inhibit the growth and recrystallization of ice by binding to the surface of ice crystals.

The compound of the present invention may self-assemble by forming a β-sheet in the x direction through hydrogen bonding mediated by aromatic amino acids, and by promoting the formation of β-sheet stacking in the y direction through π-π interactions between aromatic rings. In the compound of the present invention, the alkyl tail may enhance the hydrophobic effect in both the x and y directions, and may form an amphiphilic structure through the enthalpy-driven self-alignment of the aromatic amino acid moiety and the alkyl tail.

The 2D structure formed by the compound of the present invention may prevent the growth of ice by binding its residues to ice crystals and anchoring clathrate water molecules via nanoscale hydrophobic effects. In addition, the hydrophobic region of the 2D structure at the macroscale may effectively inhibit bulk water from approaching the ice interface, and thus may more effectively inhibit the growth of ice crystals.

The present invention provides an antifreeze method including the step of adding the above-described antifreeze composition to a sample to be subjected to antifreeze.

The antifreeze method may be a method of suppressing the freezing of the sample by adding the above-described antifreeze composition to the sample to inhibit ice growth or recrystallization.

The sample to be subjected to antifreeze may include at least one selected from the group consisting of cells, tissues, foods and pharmaceutical products. The cells, tissues, foods and pharmaceutical products may be defined within the above-described range, but are not limited thereto.

Hereinafter, the present invention will be described in detail with reference to examples.

### EXAMPLE

### 1. Design and Synthesis of Amphiphilic Peptides

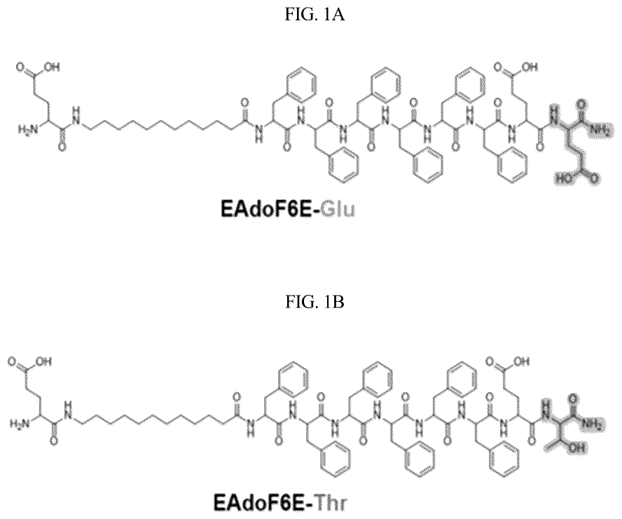

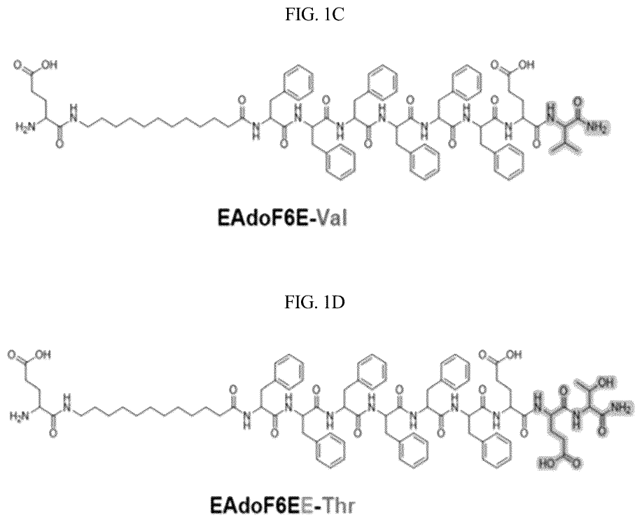

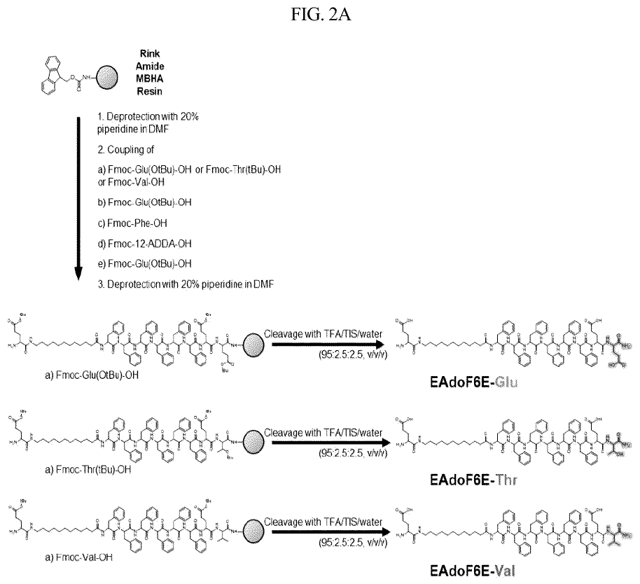

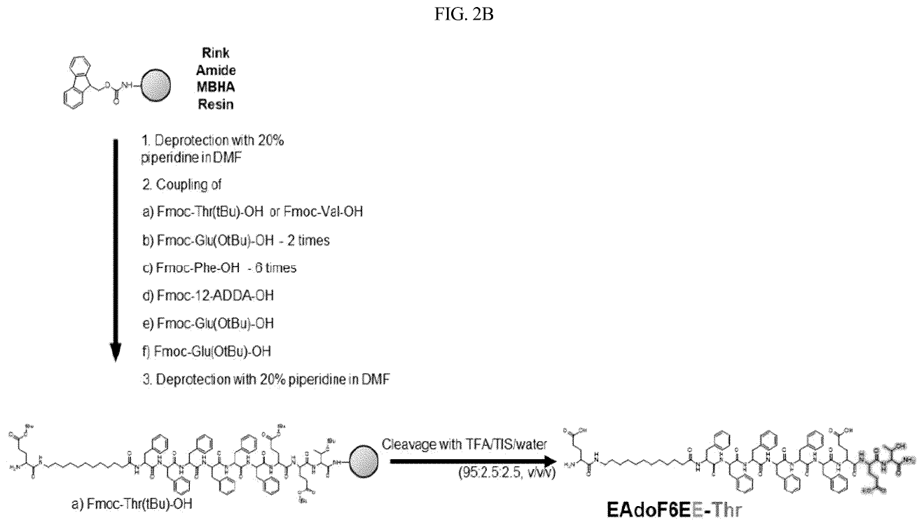

The molecular structures incorporating ice-binding moieties (IBMs) into the hydrophilic regions of amphiphilic peptides are shown in FIGS. 1A to 1D. The amphiphilic peptide molecules were specifically designed as EAdoF6E-Glu, EAdoF6E-Thr, EAdoF6E-Val, and EAdoF6EE-Thr, each molecule being different according to the IBM type. The peptides were synthesized on Rink Amide MBHA resin (100-200 mesh) by Fmoc standard solid-phase peptide synthesis (SPPS) (FIGS. 2A and 2B). Rink Amide MBHA resin (100-200 mesh), 2-(1H-benzotriazol-1-yl)-1,1,3,3-tetramethyluronium hexafluoro phosphate (HBTU), Fmoc-Thr(tert-butyl(tBu))-OH, Fmoc-Glu(OtBu)-OH, Fmoc-Phe-OH, Fmoc-Val-OH, Nile red, ammonium persulfate were purchased from Merck (Darmstadt, Germany) and GL Biochem (Shanghai, China), respectively. Fmoc-12-aminododecanoic acid (ADDA) was synthesized according to the previously known synthetic method. N,N-dimethylformamide (DMF, 99%) was purchased from Samchun Chemicals (Pyeongtaek, Republic of Korea). Dichloromethane (DCM, 99%) and diethyl ether (99.5%) were purchased from Duksan Reagents (Ansan, Republic of Korea). N-ethyldiisopropylamine (DIPEA, 99%), trifluoroacetic acid (TFA, 99%), piperidine (99%), triisopropylsilane (TIS, 98%), acetonitrile (ACN, high-performance liquid chromatography (HPLC)-grade), and ammonium hydroxide (NH₄OH) were purchased from Daejung Chemicals (Siheung, Republic of Korea) and Thermo Fisher Scientific (San Jose, CA, USA). Phosphate-buffered saline (PBS) was purchased from Corning (Corning, NY, USA).

First, after the resin was washed with DCM, it was swollen in a 1:1 v/v mixed solution of DMF and DCM for over 30 minutes in a shaking incubator. The Fmoc group on the resin was removed using 20% v/v piperidine in DMF for 3 minutes with the microwave, and the resin was thoroughly washed with DMF and DCM. Then, the mixed solution of DMF in the first amino acid selected from Fmoc-Glu (OtBu)-OH, Fmoc-Thr (tBu)-OH, or Fmoc-Val-OH (3.0 equiv.) depending on the ice-binding moiety (IBM) and HBTU (3.0 equiv.), and DIPEA (5 equiv.) was added to the resin and treated in the microwave for 10 min. Then, the Fmoc-Glu (OtBu)-OH (3.0 equiv.), Fmoc-Phe-OH (3.0 equiv.), Fmoc-12-ADDA-OH (3.0 equiv.) were coupled to the resin in a sequence of EAdoF6E-(X)-resin (E: glutamic acid, F: phenylalanine, Ado: ADDA). The success of each coupling or deprotection steps was confirmed by the Kaiser test. Then, the resin was treated with a cleavage solution (TFA:TIS:H₂O=95:2.5:2.5) for 2 h in a shaking incubator. After the cleavage reaction was completed, the remaining solution was evaporated, and the product was obtained by centrifugation with cold diethyl ether at 4000 rpm for 5 minutes three times and then dried to completely remove diethyl ether. The peptide was purified by reverse-phase HPLC using a C-18 column (SUPELCO, Discovery BIO Wide Pore C18, 5 μm, 10 mm×250 mm) using a linear gradient of DI-water (0.1% NH₄OH) and acetonitrile (0.1% NH₄OH) at a flow rate of 2 mL min-1. The molecular weight of EAdoF6E-(X) was confirmed by matrix-assisted laser desorption/ionization time-of-flight/time-of-flight (MALDI-TOF/TOF) mass spectrometry: m/z 1485.3 (1484.7 calcd for [M+H]⁺), m/z 1507.8 (1506.7 calcd for [M+Na]⁺), m/z 1523.2 (1522.8 calcd for [M+K]⁺) for EAdoF6E-Glu, and m/z 1457.3 (1456.7 calcd for [M+H]⁺), m/z 1479.1 (1478.7 calcd for [M+Na]⁺), m/z 1494.5 (1494.8 calcd for [M+K]⁺) for EAdoF6E-Thr, and m/z 1455.3 (1454.8 calcd for [M+H]⁺), m/z 1477.9 (1476.8 calcd for [M+Na]⁺), m/z 1493.2 (1492.9 calcd for [M+K]⁺) for EAdoF6E-Val.

EAdoF6EE-Thr was synthesized using the same procedure as EAdoF6E-(X) in a sequence of EAdoF6EE-Thr-resin. The resin was removed by a cleavage reaction, and the peptide was purified by reverse-phase HPLC after centrifugation. The molecular weights of EAdoF6EE-Thr were confirmed by MALDI-TOF/TOF mass spectrometry: m/z 1586.1 (1585.8 calcd for [M+H]+), m/z 1608.1 (1607.8 calcd for [M+Na]+), for EAdoF6EE-Thr.

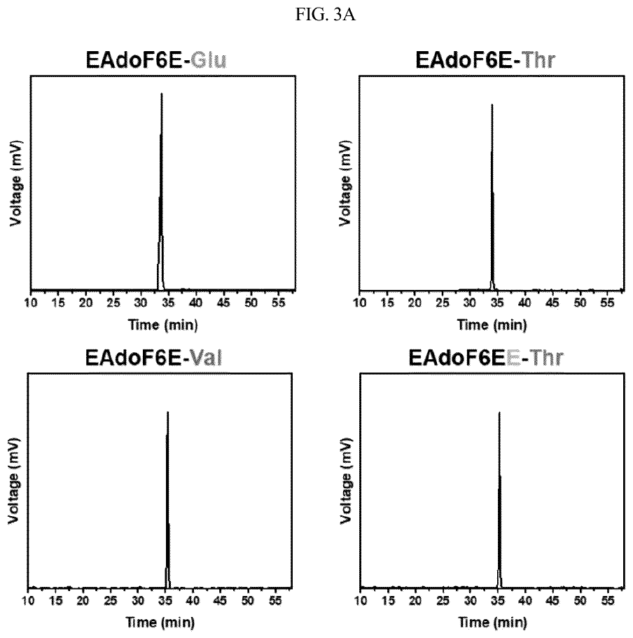

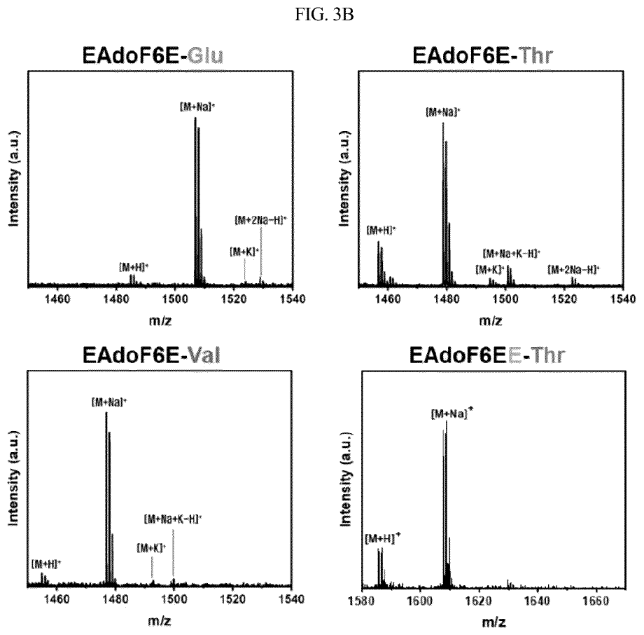

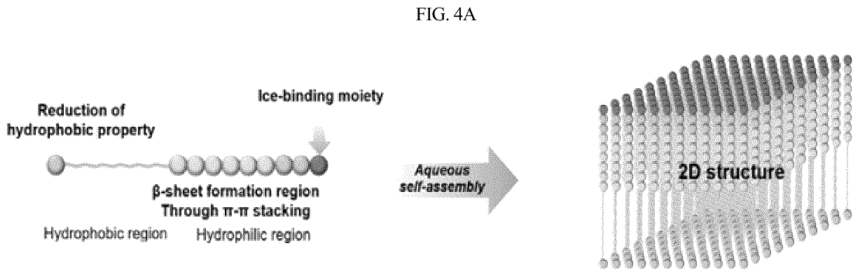

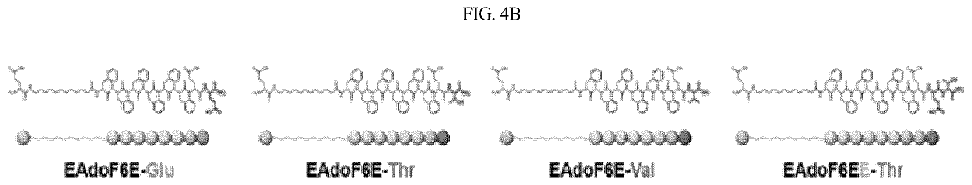

After synthesis, peptides were purified using YL9100 high-performance liquid chromatography (HPLC, Young Lin Instrument Co., Ltd., Anyang, Republic of Korea) equipped with a C18 reversed-phase chromatographic column. Mass spectrometry was performed on a Bruker Ultraflextreme matrix-assisted laser desorption/ionization time-of-flight (MALDI-TOF) mass spectrometer (Bruker Daltonik GmbH, Bremen, Germany) using a matrix of α-cyano-4-hydroxycinnamic acid dissolved in acetonitrile:water=1:1 mixed solution (0.1% NH₄OH) to confirm the synthesis of the designed peptide. The HPLC results are shown in FIG. 3A, and the MALDI-TOF/TOF results are shown in FIG. 3B.

### 2. Self-Assembly Characteristics of Amphiphilic Peptides in Aqueous Solution

### 2-1. Evaluation of Self-Assembly and Critical Micelle Concentration

To completely disrupt hydrogen bonds between peptide molecules, stock solutions of 10 mM EAdoF6E-(X) and EAdoF6EE-Thr were prepared in hexafluoroisopropanol (HFIP). Typically, 10 μL of peptide stock solution was rapidly injected into 190, 390, and 990 μL of PBS solution (10 mM, pH 7.4) to generate 0.5 mM, 0.25 mM, and 0.1 mM peptide solutions. The peptide solutions were vortexed for 10 seconds and stored overnight at room temperature. When the nanostructures are formed, the solutions appear cloudy.

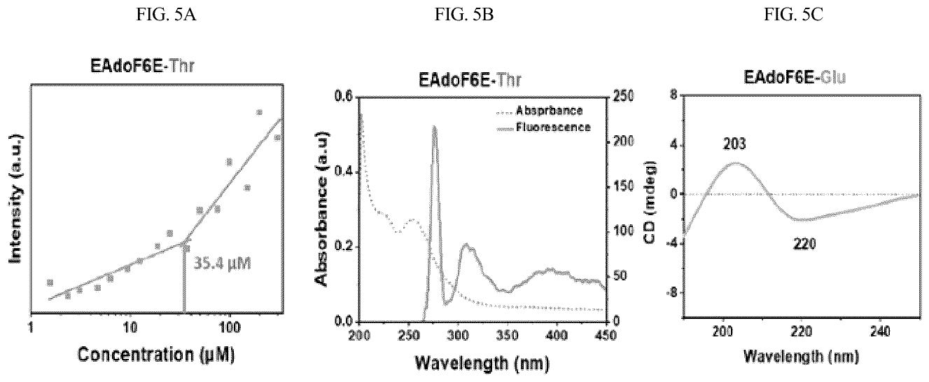

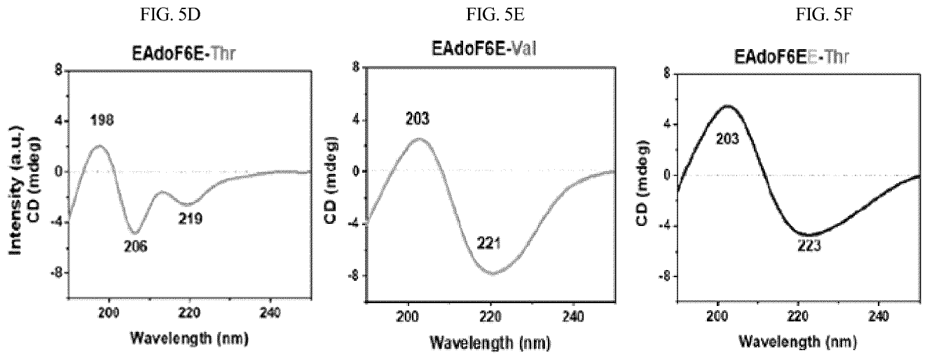

The aggregation of amphiphilic peptides was formed through self-assembly in an aqueous solution. The self-assembly of the peptides was confirmed by determining the critical micelle concentration (CMC) using Nile red. The excitation wavelength of Nile red was set to 550 nm, and the emission wavelength was set to 610 nm. A 5 nm slit was used, and the photomultiplier tube (PMT) voltage was set to 500 V. The peptide solutions were incubated with 5 μM Nile red overnight prior to measurement. The critical micellar concentration (CMC) value of the aqueous peptide solution in PBS (pH 7.4) was calculated by serial dilution in the range of 300 to 1.5 μM. The self-assembly of the peptide was confirmed at 35.4 μM, which was slightly higher than average peptide aggregation concentration, as determined from the intersection point of the linear fits in the regions of 0-30 μM and 40-300 UM (FIG. 5A).

### 2-2. UV-Vis Absorption Spectra and CD Spectra

The UV-vis absorption spectra and fluorescence emission spectra were recorded using a UH-5300 UV-Visible spectrometer (Hitachi High Technologies Corporation, Tokyo, Japan) and an F24 7100 fluorescence spectrophotometer (Hitachi High-Tech Corporation, Tokyo, Japan), respectively. The excitation wavelength was set to 250 nm, and a 5 nm slit was used. The measured photomultiplier tube voltage was set to 500 V. The measurements were performed using 0.1 mM aqueous peptide solutions. Absorption and emission intensities were measured using a 1.0 mm light path length cuvette containing an aqueous peptide solution. As a result, the UV-Vis and fluorescence spectra of EAdoF6E-Thr (0.25 mM) showed a broad peak at 400 nm, indicating the formation of higher-order aggregates of phenylalanine. Therefore, the self-assembly of the amphiphilic peptide in aqueous solution was confirmed (FIG. 5B).

The secondary structure was determined by a Jasco J-810 circular dichroism (CD) spectropolarimeter (Jasco Inc., Tokyo, Japan). Spectra were monitored from 190 to 250 nm, and the scans were repeated five times and averaged. CD spectra were used to confirm the secondary structure of the self-assembled peptide. As a result, positive peaks were observed at 198 nm for EAdoF6E-Thr, and at 203 nm for EAdoF6E-Glu, EAdoF6E-Val, and EAdoF6EE-Thr. Negative peaks were observed at 206 nm and 219 nm for EAdoF6E-Thr, 220 nm for EAdoF6E-Glu, 221 nm for EAdoF6E-Val, and 223 nm for EAdoF6EE-Thr. These peaks were red-shifted compared to the typical β-sheet peak at approximately 216 nm due to the aromatic interactions between phenylalanine residues (FIGS. 5C to 5F).

### 3. Structural Analysis of Self-Assembled Amphiphilic Peptide Nanostructures

### 3-1. Fluorescence Microscopy

To confirm the aqueous self-assembled structure, EAdoF6E-Glu was visualized using fluorescence microscopy. Fluorescence microscopy images of EAdoF6E-Glu (100 μM in PBS) stained with Nile red were obtained. Peptide self-assemblies were adsorbed onto a positively charged microscope slide for 5 minutes. The samples were mounted on 18 mm coverslips, sealed with clear nail varnish, and analyzed using fluorescence microscopy. Fluorescence images were acquired using an Eclipse Ti-E (Nikon, Tokyo, Japan) equipped with a QIClick camera (QImaging, Surrey, Canada) and an excitation filter at 475 nm (red, FITC cube).

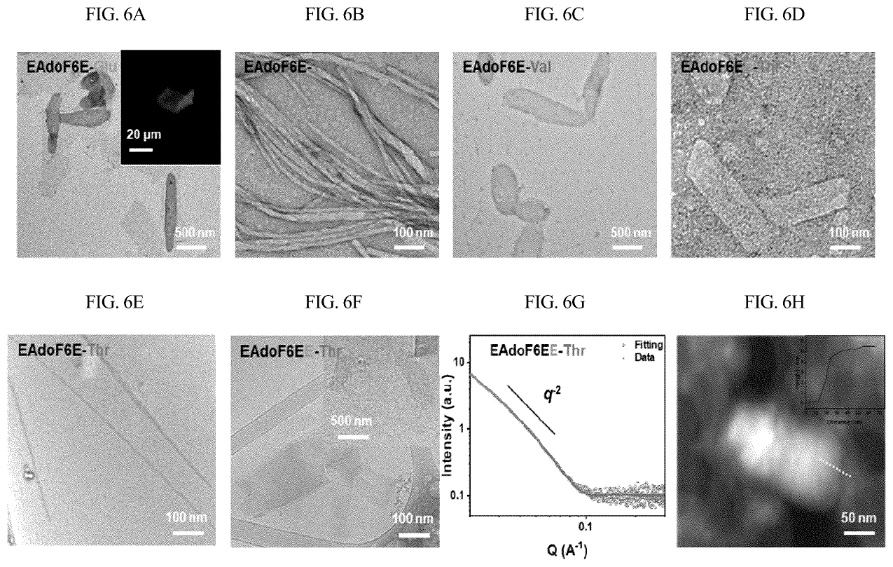

The results confirmed the presence of Nile red-stained nanosheets (inset in FIG. 6A).

### 3-2. TEM

Subsequently, the aqueous self-assembly of each amphiphilic peptide was visualized using transmission electron microscopy (TEM). To observe the self-assembled structures of the peptides, 4 μL of each peptide aqueous solution was placed on a formvar carbon-coated grid, and the solvent was allowed to evaporate under ambient conditions. Afterward, the sample-loaded grids were prepared using the negative staining method. A 2 wt % uranyl acetate solution was placed onto the sample-loaded grid, and excess solution was removed with filter paper after 3 minutes. The samples were observed using a JEM-1400 electron microscope (JEOL Ltd., Tokyo, Japan) operating at 120 kV, and the images were acquired using a side-mounted 2 k×2 k Veleta CCD camera (Olympus Soft Imaging Solutions, Münster, Germany). The images were analyzed using RADIUS imaging software.

As a result, the EAdoF6E-Glu and EAdoF6E-Val molecules, arranged in a β-sheet pattern due to π-π stacking and hydrogen bonding of phenylalanine, formed nanosheets (FIGS. 6A and 6C). EAdoF6E-Thr, with Thr amino acid residues introduced to bind with ice, formed nanofibrils (FIG. 6B). These results suggest that the incorporation of Thr weakened the electrostatic repulsion between Glu residues and distorted the packing of the β-sheet, resulting in twisted nanofibrils. The nanofibrils were formed with a thickness of tens of nanometers and a length of hundreds of nanometers. In the case of EAdoF6EE-Thr, nanosheets were formed through the additional introduction of Glu residues (FIG. 6D), showing homogeneous nanosheets with a width of several hundred nanometers and a length of several micrometers.

### 3-3. Cryo-TEM

Cryo-TEM (Cryogenic-TEM) was used to observe the native state images. The process of loading the aqueous peptide solution onto the grid for cryo-TEM analysis was prepared under ambient conditions with a humidity range of 97-99%, utilizing the Vitrobot Mark IV (Thermo Fisher Scientific, Waltham, MA, USA). A volume of 4 μL of aqueous peptide solution was deposited on a lacey-supported grid, and then the excess solution was removed by filter paper blotting for 1 second. These grids with the applied solution were rapidly vitrified by plunge freezing in liquid ethane. The peptide aqueous solution-loaded grid was transferred to a Gatan 914 cryo-holder within a Gatan cryo stage (Gatan Inc., Pleasanton, CA, USA). Then, the cryo-holder moved into a JEM-1400 microscope (JEOL Ltd., Tokyo, Japan). Cryo-TEM images were obtained using the XAROSA bottom-mounted CMOS camera (EMSIS GmbH, Münster, Germany), with the subsequent image analysis conducted using RADIUS imaging software (Olympus Soft Imaging Solutions GmbH, Münster, Germany).

As a result, it was confirmed that EAdoF6E-Thr formed nanofibrils (FIG. 6E) and EAdoF6EE-Thr formed nanosheets (FIG. 6F).

### 3-4. Small-Angle X-Ray Scattering and Atomic Force Microscopy

Small-angle X-ray scattering (SAXS) measurements were performed on the PLS-II 9A U-SAXS beamline at Pohang Accelerator Laboratory (PAL, Pohang, Republic of Korea) with an X-ray energy of 11.08 keV (Didcot, UK). A 0.25 mM aqueous peptide solution in PBS (pH 7.4) and the solvent was measured in a 1.7 mm quartz glass capillary, and the scattered X-ray intensity was collected. The resulting plot of scattered X-ray intensity was generated by subtracting the contributions of solvent and capillary. Structural assessment of the self-assembled peptides was achieved by fitting the scattering data using the Sas View fitting software with the LamellarModel, which is suitable for plate-like structures.

The results confirmed the plate-like structure of EAdoF6EE-Thr with a Q⁻² decay in the Guinier region and q value in the Fourier region, indicating the presence of nanosheets with a thickness of approximately 5.0 nm (FIG. 6G).

Quantitative evaluation of the thickness of the structure was performed by fitting it to a lamellar sheet, and the thickness was indicated as approximately 5.5 nm, which was confirmed by AFM measurement (FIG. 6H). A volume of 5 μL of aqueous peptide solution at a 0.25 mM concentration was deposited onto freshly cleaved mica substrate. 2D sheet images on the mica substrate were gained using the atomic force microscope (AFM) (Park Systems Inc., Suwon, Republic of Korea) in tapping mode. In soft tapping conditions, AFM cantilevers (Park Systems Corporation, Suwon, Republic of Korea) were used at a vibration frequency of 287 kHz. The measurements were performed in an ambient atmosphere. The images were processed using XEI software.

### 4. IRI Activity and DIS Analysis of Self-Assembled Amphiphilic Peptide Nanostructure

### 4-1. Confirmation of IRI Activity

Because the self-assembled amphiphilic peptide nanostructure manufactured in the above example has the advantage of forming the Janus structure, its IRI activities were confirmed by a splat assay, in which ice grains are grown by recrystallization over time. A volume of 10 μL of peptide dispersions with a concentration of 0.25 mM in PBS (pH 7.4) was prepared freshly before use and dropped from a height of 1.0 m onto the surface of a precooled coverslip using liquid nitrogen (−150° C.) to make a thin film of ice. A Linkam BCS 196 cryo stage (Linkam Scientific Instruments, Salford, UK) mounted on an Eclipse LV100POL polarizing microscope was set to −20° C. The glass coverslip with the ice-thin film was transferred onto the cryostage. Then, the temperature of the glass coverslip was gradually increased to −8° C. at a rate of 5° C./min. Images were taken at 10 min intervals from the initial state to 30 minutes later using a microscope equipped with LU Plan Fluor 10×/0.30 and LU Plan ELWD 20×/0.40 lenses and a DS-Ri1 digital camera (Nikon, Tokyo, Japan). The image data were extracted using NIS-Elements imaging software (Nikon Instruments Inc., Tokyo, Japan). Image processing was conducted using ImageJ. To evaluate IRI activity, ten of the largest ice domains in the field of view were selected, and their sizes were averaged. The mean largest grain size (MLGS) and its standard deviation were calculated in three individual experiments. The average values were compared to the control PBS value.

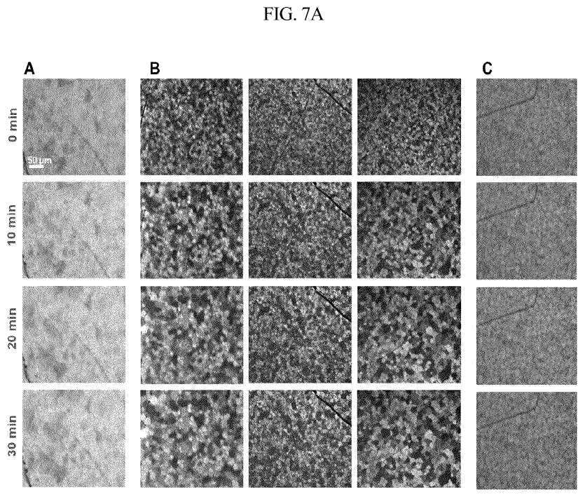

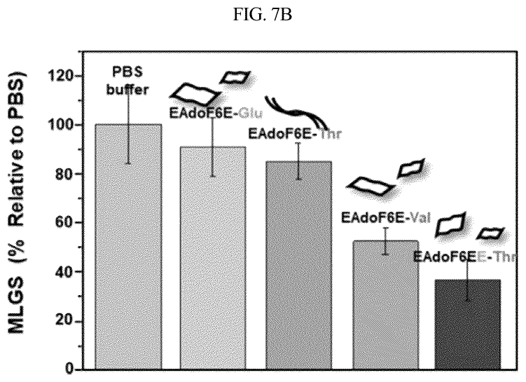

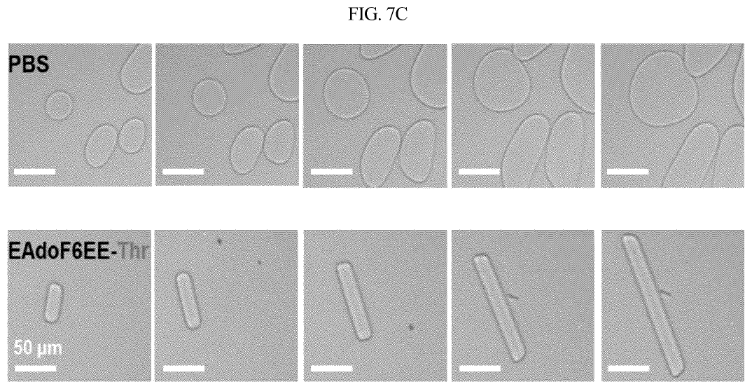

A in FIG. 7A shows the ice grain recrystallization image of the control PBS, and B in FIG. 7A shows the ice recrystallization images of EAdoF6E-Glu, EAdoF6E-Thr, and EAdoF6E-Val. C in FIG. 7A shows the ice recrystallization images of EAdoF6EE-Thr. FIG. 7A shows the mean largest grain size (MLGS) of the ice crystals, quantitatively representing the IRI activity of each peptide. EAdoF6E-Glu, which uses Glu as the IBM, exhibited almost no IRI effect compared to the control PBS due to the lack of ice-binding residues capable of hydrogen bonding with ice. EAdoF6E-Thr, which formed nanofibrils and contains Thr that can bind to ice, showed minimal IRI effect due to the limited ice-binding surface area. EAdoF6E-Val, having a nanosheet that can inhibit the approach of water molecules with Val, exhibited enhanced IRI behavior (with an MLGS of 45% relative to PBS). EAdoF6EE-Thr, using Thr as the IBM and having a nanosheet structure, showed superior IRI activity.

### 4-2. Dynamic Ice Shaping (DIS) Analysis

Next, the inventors carried out a sandwich assay to evaluate the ice-shaping ability through peptide-ice binding. A volume of 1 μL of a 0.25 mM peptide solution dissolved in PBS (pH 7.4) was dropped onto a coverslip, covered with another coverslip, and sealed with nail polish to form a sandwich. The coverslip containing the sandwiched sample was cooled to −30° C. using a Linkam BCS 196 cryo stage (Linkam Scientific Instruments, Salford, UK) and held for 10 minutes. Once ice nucleation occurred at −30° C., the temperature was raised to −10° C. at a rate of 5° C./min and then heated at a rate of 0.5° C./min to form single ice crystals. When a few ice crystals remained, the temperature was lowered at a rate of 0.05° C./min to induce ice crystal growth, and the ice growth and shape over time were measured. Images were captured using a microscope with LU Plan Fluor 10×/0.30 and LU Plan ELWD 20×/0.40 lenses and equipped with a DS-Ril digital camera (Nikon, Tokyo, Japan). The image data were analyzed using NIS-Elements imaging software (Nikon Instruments Inc., Tokyo, Japan).

The upper image in FIG. 7C shows the results of an ice shaping experiment using PBS, confirming that the ice grew isotropically over time. In contrast, in the case of EAdoF6EE-Thr, anisotropic ice growth was observed, indicating that the peptide binds to specific crystal faces of the ice, thereby inducing anisotropic growth (lower image in FIG. 7C). Therefore, the peptide nanostructures bound to the ice may attach to particular crystal planes, allowing them to control the shape of the ice crystals and inhibit their growth.

What is claimed is:

1. An antifreeze composition comprising a self-assembled nanostructure of a compound represented by Formula 1A: 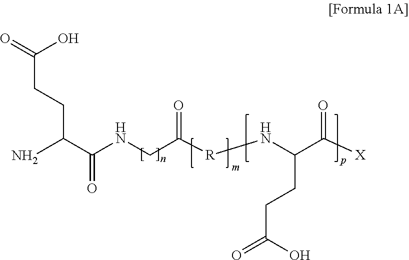
wherein R is phenylalanine, tyrosine or tryptophan;
X is valine, glutamic acid or threonine;
nis an integer from 5 to 20;
m is an integer from 4 to 8; and
p is 1 or 2.

2. The antifreeze composition according to claim 1, wherein the compound represented by Formula 1A is any one of the compounds represented by Formulas 2 to 5 below:

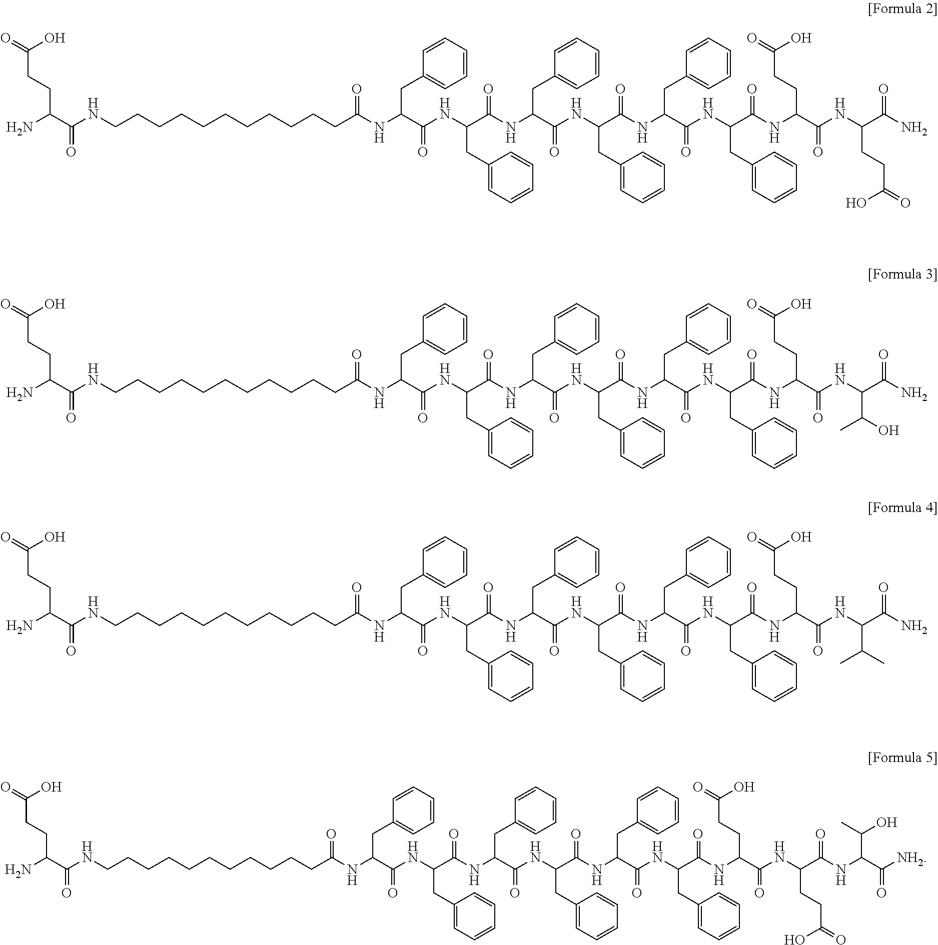

3. The antifreeze composition according to claim 1, wherein the nanostructure is a nanosheet or a nanofibril.

4. The antifreeze composition according to claim 3, wherein the nanostructure is a nanosheet is the nanosheet having a thickness of 2 to 10 nm.

5. The antifreeze composition according to claim 1, wherein the nanostructure has a Janus structure.

6. The antifreeze composition according to claim 1, wherein the self-assembly nanostructure results from hydrogen bonding between the compounds represented by Formula 1A.

7. The antifreeze composition according to claim 1, wherein the self-assembly nanostructure results from π-π interactions between the compounds represented by Formula 1A.

8. The antifreeze composition according to claim 1, wherein the X group binds to the surface of ice to inhibit the growth of ice.
